(19) United States
(12) Patent Application Publication
(10) Pub. No.: US 2008/0004774 A1
(43) Pub. Date: Jan. 3, 2008

(54) System and method for child safety in a vehicle

(76) Inventors: Ann A. Wieczorek, San Diego, CA (US); Ardell G. Wieczorek, Brookings, OR (US); Donald S. Wieczorek, Brookings, OR (US); Mark D. Wieczorek, San Diego, CA (US)

Correspondence Address: MAYER & WILLIAMS PC, 251 NORTH AVENUE WEST, 2ND FLOOR, WESTFIELD, NJ, 07090, US

(21) Appl. No.: 11/480,742

(22) Filed: Jul. 3, 2006

(51) Int. Cl. B60R 22/00

(52) U.S. Cl. 701/45

(57) ABSTRACT

A method and device to warn parents or other caregivers that a child has been inadvertently left in a child safety seat in a vehicle. The system generally includes at least one child sensor coupled to a processor, at least one trigger coupled to the processor, and an alarm coupled to the processor. The child sensor is generally any sensor that can sense the presence of a child in a safety seat. The trigger is generally any sensor that can determine if a danger would exist to a child in a vehicle.

### BACKGROUND OF THE INVENTION

Despite numerous advances in child safety seat systems, human error in the use of the same still leads to unnecessary and preventable tragedy. For example, it seems unfortunately all-too-common that parents or other caregivers forget that their children are in a child safety seat, and subsequently they accidentally forget to remove their children from a vehicle. In cases where the temperature inside the vehicle rises to high temperatures, many such children perish from hyperthermia, oxygen deprivation, exposure, or other deleterious consequences. On the opposite extreme, many children perish from hypothermia or other deleterious consequences when left in a vehicle in low temperatures.

### SUMMARY OF THE INVENTION

Systems disclosed here provided methods and devices to warn parents or other caregivers that a child has been left in a child safety seat in a vehicle. The systems generally include at least one child sensor coupled to a processor, at least one trigger coupled to the processor, and an alarm coupled to the processor. The child sensor is generally any sensor that can sense the presence of a child in a safety seat. The trigger is generally any sensor that can determine if a danger would exist to a child in a vehicle.

Advantages of the embodiments of the invention may include one or more of the following. The system and method may be employed to prevent an individual inadvertently left in a vehicle from succumbing to hyperthermia, hypothermia, exposure, suffocation, or other deleterious condition. The system and method may be particularly appropriate to sense the presence of a child who is facing backward in a child safety seat, as the same is difficult for a driver to immediately see in a rearview mirror. If such a child is sleeping, there is no reminder to the driver to remove the child from the vehicle. Of course, the invention may apply to child or other individuals facing in any direction in a vehicle or other enclosed space.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

Included in the drawings are the following figures:

FIG. 1 shows a schematic diagram of a child safety system.

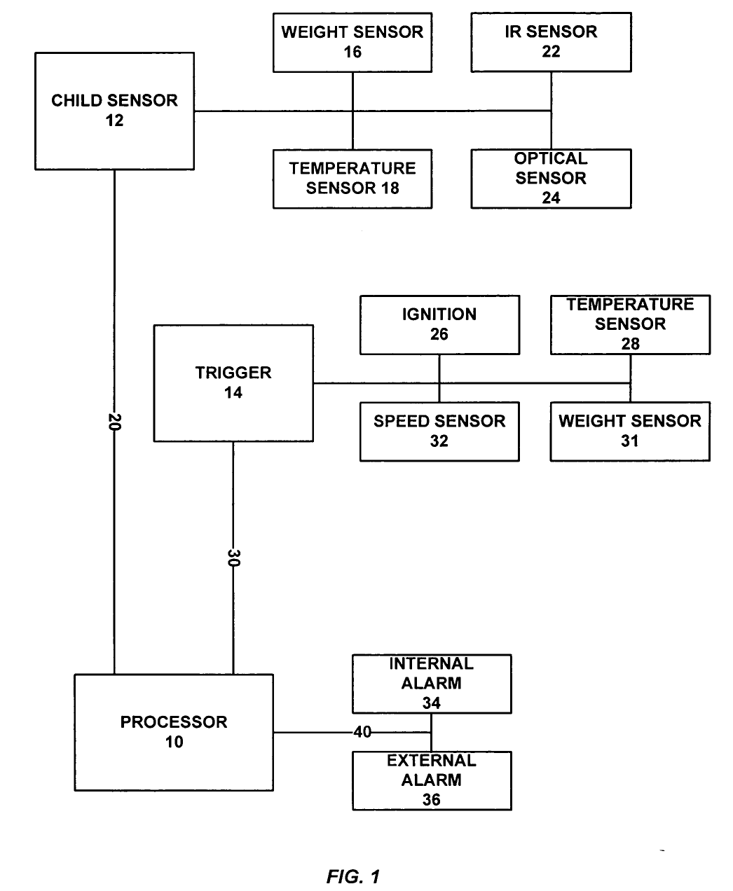

FIG. 2 shows a flowchart of a method for child safety.

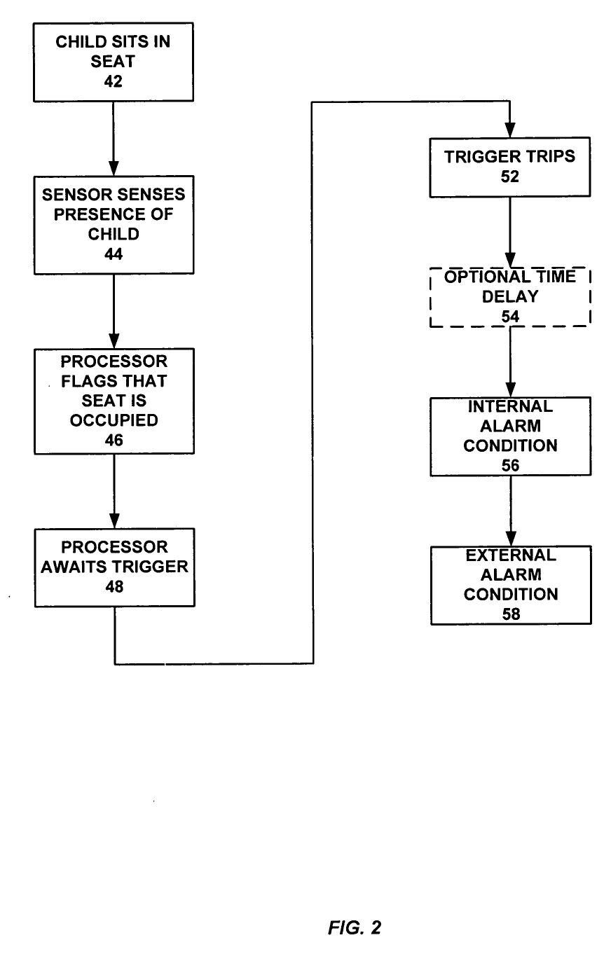

### DETAILED DESCRIPTION

Before the subject devices, systems and methods are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context clearly dictates otherwise. Thus, for example, reference to “a sensor” may include a plurality of such sensors and reference to “the trigger” includes reference to one or more triggers and equivalents thereof known to those skilled in the art, and so forth.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The present invention will now be described in greater detail by way of the following description of exemplary embodiments and variations of the systems and methods of the present invention.

The systems generally include at least one child sensor 12 coupled to a processor 10, at least one trigger 14 coupled to the processor, and an alarm 34 and/or 36 coupled to the processor. The child sensor can be, e.g., a weight sensor 16, a temperature sensor 18, an infrared sensor 22, an optical sensor 24, or any other sensor that can sense the presence of a child in a child safety seat. For example, a weight sensor may be disposed at the base of the child safety seat, on either side of an optional seat cover, generally where the child's posterior would be disposed. Thus, the weight of the child would impinge on the sensor and indicate that the child is disposed in the car seat. A temperature sensor disposed in the same location would generally sense the temperature of the child. A threshold discriminator in the processor would then be employed to determine whether a child is disposed in the seat or not. An infrared sensor may also be employed to sense the temperature and thus the existence of the child, and the same or an optical sensor could also be used in a “broken beam” configuration to sense if a child is disposed in the seat or not (a broken beam indicating the presence of the child, and a continuous beam indicating the absence of the child). Other sensors may include auditory sensors, smell sensors, or any other type of sensor that can sense the presence of an individual in a vehicle.

The couplings 20, 30, and 40 between the processor and the child sensor, trigger, and alarm can be a wired or wireless connection, and can be optionally integrated with a processor responsible for vehicle functions. If a wireless connection, the same may be via Bluetooth or any other such wireless communications scheme.

The trigger can be a sensor that senses the operation of the vehicle, the temperature within the vehicle, or any other sensor that can determine if a deleterious condition exists for a child disposed therein. The trigger may be directly connected to the ignition 26, to sense if the vehicle is turned on or off. The trigger may also be connected to a speedometer 32 or other indicator of motion in a vehicle. The trigger may also be a weight sensor 31 connected to the driver seat, e.g., to sense the weight of a driver in the driver seat. Any other sensor may also be considered a trigger that senses if a dangerous condition exists for a child.

The trigger may sense conditions that are dangerous in the absence of a parent or caregiver as well as conditions that are dangerous even in the presence of a parent or caregiver, such as dangerous temperature conditions, via use of temperature sensor 28.

Other potential triggers include an engine noise sensor or engine heat sensor placed in the engine compartment of the vehicle. For both cases, a decrease in either may be recognized as the vehicle ceasing motion, and each would be convenient to retrofit, especially where such sensors are provided with a wireless communications capability. Many of the triggers disclosed above may also be convenient to retrofit.

In some embodiments, multiple sensors are provided for redundancy. For example, if a parent or caregiver suffers an illness that makes response or other child care impossible, the other sensor can still cause an alarm. In a particular example, if the parent suffers a heart attack in the seat, a driver seat sensor would not cause an alarm. If, however, the temperature rises deleteriously, a redundant temperature sensor may still cause an alarm to occur.

The alarm may be an internal alarm 34 or an external alarm 36 or both. An internal alarm may be employed to notify the parent or caregiver of an alarm condition, and may take the form of an audible sound or visual alert that causes the parent or caregiver to take notice of the child. An external alarm may be similar to a “car alarm” used for theft prevention or deterrence. The alarm system may be designed such that, initially, an internal alarm is provided. This is termed an initial alarm condition. If the initial alarm condition is unabated or otherwise not responded to, the external alarm may ensue. In this way, a progressively more noticeable alarm is provided to cause a parent, caregiver, or passerby to respond if they are away from the vehicle and missed the initial internal alarm. While not required, the alarm may have a different sound than the car theft deterrent alarm, so as to alert the parent, caregiver, or passerby that an even greater emergency is present.

In use, when a child is placed in the seat (step 42), as determined by the child sensor (step 44), the system including the processor enters a “child present” state (step 46). The system then is in a waiting mode until a trigger is tripped (step 52). Once a trigger is tripped, an alarm state is caused, leading to one or more alarms as noted above. The actual alarm alert may be instigated following a short time delay (step 54), e.g., 10-60 seconds, to allow the parent or caregiver to remove the child from the child safety seat, as is described in greater detail below.

The trigger may be tripped by the ignition switch being turned off via an appropriate sensor, the engine being turned off as sensed by an appropriate sensor, the driver exiting from the driver seat as determined by a weight or temperature sensor in or on the driver seat, or other such trigger. A combination of these triggers may also be employed for redundancy. Generally these and other such triggers indicate that the parent or caregiver has exited or is about to exit and leave the vicinity of the vehicle. Another trigger, which may be used in combination with the above for redundancy, may be an internal vehicle temperature sensor. If the trigger trips, and the child sensor indicates that the child has not been removed from the child safety seat after a predetermined period of time, e.g., 30 seconds, one or more of the alarms may sound or optically indicate to the parent or caregiver that the child has been left in the vehicle and that the same should indeed be removed as soon as possible. In many cases, initially an internal alarm may sound (step 56), followed by an external alarm (step 58) in the case where no response is received to the initial alarm.

In vehicles equipped with wireless communications capabilities to an external network, such as the OnStar® system, an alarm signal may be sent to the network to cause an emergency response team to respond and rescue the child or individual in the vehicle. In some case, the vehicle may be caused to have its windows rolled down as a result of the alarm signal.

While the term “child safety seat” has been employed through the specification, the term is intended to cover any such seat for a child, including a booster seat, a child carrier with or without a base, or any other seat that a child may sit on, including merely a seat pad of any size with a sensor disposed therein. While the term at least one sensor has been employed, a plurality of sensors may be employed for redundancy and to ensure that the child is sensed by at least of the plurality while seated in the child safety seat.

A vehicle may have the safety system, and particular the processor, integrated into the microprocessor that is responsible for its operation, or the safety system may be retrofitted into a vehicle with no such predisposition. For example, the child sensor may be installed onto an existing child safety seat. The trigger may be installed into the engine compartment or the passenger compartment of the vehicle. The processor may be disposed in a freestanding box in the passenger compartment along with an alarm. The processor may then be coupled to the child sensor and the trigger via a wired or wireless connection, or a combination of both.

The trigger may be deactivated in case no children are present, or the system may automatically deactivate when no child sensor signal is received. However, in many embodiments, where children occasionally ride in the car, the system may prompt the user to affirmatively deactivate the system each time the car is started so that the same is not inadvertently left in an “off” state.

While the term “child” has been employed through the specification, the term is intended to cover any individual who by reason of age, infirmity, or any other reason, is generally unable to exit a vehicle on their own. Indeed, the invention may well cover pets, although the greater mobility of pets may require a more sophisticated sensing system.

While the term “vehicle” has been employed through the specification, the term is intended to cover any generally enclosed space, especially those used for transportation, where the exit of a parent or caregiver would deleteriously affect an individual inadvertently left therein. Typically, a vehicle is a car or truck in which a child has been placed in a car safety seat.

The active alarm system may be integrated with a passive or active camera system to allow the parent or caregiver to view the child or other such occupant of a child safety seat.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A system for child safety, comprising:
a. A child sensor to sense the presence of a child;
b. A trigger to sense a dangerous condition in a vehicle;
c. An alarm; and
d. A processor to receive signals from the child sensor and the trigger, wherein the processor causes the alarm to activate if the trigger trips while the child sensor is sensing the presence of a child.

2. The system of claim 1, wherein the child sensor is selected from the group consisting of: weight sensors, infrared sensors, optical sensors, and temperature sensors.

3. The system of claim 1, wherein the trigger is selected from the group consisting of: weight sensors, ignition sensors, temperature sensors, and sound sensors.

4. The system of claim 3, further comprising two triggers, wherein one trigger is selected from the group consisting of: weight sensors, ignition sensors, temperature sensors, and sound sensors, and the other trigger is a temperature sensor to sense the temperature inside the vehicle.

5. The system of claim 1, wherein the alarm is an internal alarm or an external alarm.

6. The system of claim 5, wherein the alarm is an internal alarm and an external alarm, wherein the internal alarm sounds prior to the external alarm.

7. The system of claim 6, wherein the external alarm is a siren.

8. The system of claim 1, wherein the processor is integral with or communicatively coupled to a processor in the vehicle.

9. The system of claim 1, wherein the processor is not integral with or communicatively coupled to a processor in the vehicle.

10. The system of claim 1, wherein the trigger and the child sensor are communicatively coupled to the processor by a wired connection.

11. The system of claim 1, wherein the trigger and the child sensor are communicatively coupled to the processor by a wireless connection.

12. A method of keeping a child safe, comprising:
a. Receiving a signal at a processor from a child sensor that a child has been placed in a child safety seat;
b. Receiving a signal at a processor from a trigger that a dangerous condition may ensure in a vehicle.
c. Causing an alarm to sound or visually appear.

13. The method of claim 12, wherein the child sensor is selected from the group consisting of: weight sensors, infrared sensors, optical sensors, and temperature sensors.

14. The method of claim 12, wherein the trigger is selected from the group consisting of: weight sensors, ignition sensors, temperature sensors, and sound sensors.

15. The method of claim 12, wherein the alarm is an external siren.

16. The method of claim 12, wherein the processor is integral with or communicatively coupled to a processor in the vehicle.

17. The method of claim 12, wherein the processor is not integral with or communicatively coupled to a processor in the vehicle.

18. The method of claim 12, further comprising communicating a signal corresponding to the alarm to a wireless network.

19. The method of claim 12, wherein the processor communicates with the trigger or the child sensor in a wired or a wireless manner.

20. A computer program, residing on a computer readable medium, comprising instructions for causing a processor to:
a. Receive a signal at a processor from a child sensor that a child has been placed in a child safety seat;
b. Receive a signal at a processor from a trigger that a dangerous condition may ensure in a vehicle.
c. Cause an alarm to sound or visually appear.
